(19) United States
(12) Patent Application Publication
(10) Pub. No.: US 2015/0318925 A1
(43) Pub. Date: Nov. 5, 2015

(54) COMMUNICATION APPARATUS AND METHOD

(71) Applicant: THE UNIVERSITY COURT OF THE UNIVERSITY OF EDINBURGH, Edinburgh (GB)

(72) Inventors: Dobroslav TSONEV, Edinburgh (GB); Sinan SINANOVIC, Edinburgh (GB); Harald HAAS, Edinburgh (GB)

(21) Appl. No.: 14/648,174

(22) PCT Filed: Nov. 29, 2013
(86) PCT No.: PCT/GB2013/053178

§ 371 Date: May 28, 2015

(30) Foreign Application Priority Data
Nov. 30, 2012 (GB) 1221600.8

(51) Int. Cl. H04B 10/508; H04B 10/516; H04L 27/26

(52) U.S. Cl. CPC H04B 10/508; H04L 27/2626; H04B 10/516

(57) ABSTRACT

A method and associated transmission system, signal processor and communications system for converting a signal from a bipolar signal Into a unipolar signal, the method involving applying a pulse shaping filter to the bipolar signal to produce a pulse shaped bipolar signal; and subsequently transforming the negative values of the pulse shaped bipolar signal to produce the unipolar signal. Preferably, the bipolar signal and/or the shaped bipolar signal and/or the unipolar signal have a plurality of frames, and the frames have at least one guard interval, wherein the guard interval(s) include a prefix provided before or at the start of at least one frame and/or a suffix provided after or at the end of at least one frame.

The present invention relates to a method and apparatus for converting a bipolar signal into a unipolar signal and/or a discrete time signal into a continuous time signal and an associated receiver, preferably but not essentially relating to optical communications.

### BACKGROUND

Orthogonal frequency division multiplexing (OFDM) methods are popular for modulating signals in order to transmit data over dispersive channels. However, it is desirable to reduce the power consumption of communication systems. For example, this may be to maximise battery life for portable devices, or simply to save operating costs or reduce energy usage.

A variation on the OFDM modulation scheme, called SIM-OFDM, has been proposed in order to reduce the power required by communications devices relative to those that use traditional OFDM. The SIM-OFDM technique is described in “Subcarrier Index Modulation OFDM” by R. Abualhiga and H. Haas, in Proc. of the International Symposium on Personal, Indoor and Mobile Radio Communications (PIMRC), Tokyo, Japan, Sep. 13-16, 2009.

SIM-OFDM introduces an additional dimension alongside conventional OFDM encoding, the additional dimension coming from the state, i.e. active or inactive, of each frequency carrier evadable. In this way, frequency carrier states (i.e. used or unused) are used to encode data according to an on-off keying modulation scheme. As in OFDM, each active carrier transmits a signal that is modulated using a conventional modulation scheme such as but not limited to M-QAM. Each inactive carrier is set to a zero state. Hence, the power used to convey each M-QAM signal can also be used to encode further data by simply being present or not in a particular frequency carrier band. The SIM-OFDM concept is illustrated in FIG. 3.

In this case, the incoming bit stream is divided into blocks of bits, each having a length of N(0.5*log2(M)+1), where N is the number of frequency carriers, and M is the constellation size of the respective M-QAM modulation scheme that is used. Each of these blocks is divided into two parts. The first N bits of the block form a first sub-block (B_{OOK}). The remaining 0.5*N·log₂(M) bits form a second sub-block (B_{QAM}). The first sub-block (B_{OOK}) is inspected and the majority bit type is determined by checking which bit value, 1 or 0, has most occurrences. The frequency carders that have the same position inside the OFDM frame as the bits from the majority bit type in B_{OOK} are classified as “active”, and the rest of the frequency carriers (i.e. those that correspond to the minority bit type) are classified as “inactive”. Inactive carriers are given the amplitude value 0+0j, where j=√−1. The first 0.5*N active frequency carriers are given amplitude values corresponding to the M-QAM constellation symbols necessary to encode the second sub-block (B_{QAM}). The remaining active carriers can be used to signal the majority bit type of B_{OOK} to the destination receiver and they will be assigned a signal whose power is equal to the average power for the given M-QAM scheme. Afterwards, an N-point IFFT transformation is performed in order to obtain the time-domain signal, which is transmitted.

In this way, for example, if the binary sequence [0 1 0 0 0 1 1 1 0 1 0 1] is to be transmitted using 4-QAM and 6 carriers, then the sequence is divided into a first sub-block [1 1 0 1 0 1] and a second sub-block [0 1 0 0 0 1]. The second sub-block is modulated into frequency carriers using 4-QAM modulation. Since the majority bit in the first sub-block is 1, then an active carrier is chosen to represent 1. In this case, the 4-QAM modulated signals are transmitted on the first, third and fifth frequency carrier channels. The sixth carrier, which is also active, can be used to convey to the destination what the majority bit type in B_{OOK} is. It will be allocated power equal to the average power of the respective M-QAM scheme. Its positive amplitude will represent the majority bit type—in this case 1. This carrier channel allocation effectively encodes the first sub-block as [1 1 0 1 0 1].

A slight modification of SIM-OFDM involves signalling the majority bit type either through secure communication channels, or by reserving one particular frequency carrier and transmitting the desired value with a sufficiently high signal to noise ratio. It should also be noted that this modulation scheme saves power from all inactive carriers at the expense of spectral efficiency. The described configuration has been referred to as Power Saving Policy (PSP). In an alternative embodiment, for each single OFDM frame, the unused power from the inactive carriers can be reallocated to the active ones, which could lead to a performance enhancement.

Once a signal has been received by the receiver at the destination, it is transformed into the frequency domain with a fast Fourier transform operation. Then all the frequency carriers are inspected. Those carriers whose power is above a predetermined threshold are marked as active, and the rest of the carriers are marked as inactive. At least half of the total number of carriers are active. Hence, in case that less than 0.5*N active carriers are detected, the threshold value is decreased by a small step and the inspection is performed again. This procedure is done iteratively until at least 0.5*N active carriers are detected. Then the first sub-block (B_{OOK}) is reconstructed from the detected states of the carriers and the known majority bit type. Afterwards, the first 0.5*N active carriers are demodulated according to the respective M-QAM scheme in order to reconstruct the second sub-block (B_{QAM}) in the conventional manner. The spectral efficiency of this scheme is:

$$\frac{{log}_{2} ( M )}{2} + 1 \frac{bits}{carrier}$$

It is an object of at least on embodiment of the present invention to improve the performance of the SIM-OFDM scheme. The bit error rate (BER) performance of SIM-OFDM in an Additive White Gaussian Noise (AWGN) channel is illustrated in FIG. 4.

Wireless data traffic is increasing exponentially [“Visible Light Communication (VLC)—A Potential Solution to the Global Wireless Spectrum Shortage,” GBI Research, Tech. Rep., 2011. [Online]. Available: http://www.gbiresearch.com/, herein incorporated by reference]. Despite the continuous improvements in wireless communication technology, it is expected that the future demand cannot be met because the radio frequency spectrum has been almost completely utilised. A potential solution to the emerging problem is the development of optical wireless communication. Main advantages of an optical wireless system are: (a) a lot of unregulated bandwidth, (b) license-free operation, (c) low-cost front end devices, (d) no interference with the operation of sensitive electronic systems, (e) reuse of the existing lighting infrastructure, and (f) no health concerns related to visible light as long as eye-safety regulations are met [H. Elgala, R. Mesleh, and H. Haas, “Indoor Optical Wireless Communication: Potential and State-of-the-Art,” IEEE Commun. Mag., vol. 49, no. 9, pp. 56-62, Sep. 2011, ISSN: 0163-6804, herein incorporated by reference].

The physical properties of light emitting diodes (LEDs) and photodiodes (PDs) characterise a visible light communication (VLC) system as an intensity modulation/direct detection (IM/DD) system. In other words, only signal intensity and no phase or amplitude can be conveyed. This fact limits the set of modulation schemes which can be employed. Techniques like on-off keying (OOK), pulse-position modulation (PPM), and pulse-amplitude modulation (PAM) can be applied in a straightforward fashion. With the increase of transmission rates, however, intersymbol interference (ISI) becomes an issue. Hence, a more resilient technique like orthogonal frequency division multiplexing (OFDM) becomes desirable. Conventional OFDM signals are complex and bipolar in nature. It is possible to generate real OFDM signals by imposing Hermitian symmetry on the carriers in frequency domain at the expense of half the spectral efficiency [H. Elgala, R. Mesleh, and H. Haas, “Indoor Optical Wireless Communication: Potential and State-of-the-Art,” IEEE Commun. Mag., vol. 49, no. 9, pp. 56-62, Sep. 2011, ISSN: 0163-6804]. The bipolarity of signals, however, introduces an additional problem in VLC since LEDs can only be modulated with strictly positive signals. The issue can be solved by introducing a DC-bias, which increases the power dissipation of the system and cannot be easily optimised for all constellation sizes of quadrature amplitude modulation (M-QAM) used to modulate the different OFDM carriers. This technique is known as DC-biased optical OFDM (DCO-OFDM). Three power efficient alternatives to DCO-OFDM have been proposed in previous works: asymmetrically clipped optical OFDM (ACOOFDM) [J. Armstrong and A. Lowery, “Power Efficient Optical OFDM,” Electronics Letters, vol. 42, no. 6, pp. 370-372, Mar. 16, 2006. herein incorporated by reference], pulse-amplitude-modulated discrete multitone modulation (PAM-DMT) [S. C. J. Lee, S. Randel, F. Breyer, and A. M. J. Koonen, “PAM-DMT for Intensity-Modulated and Direct-Detection Optical Communication Systems,” IEEE Photonics Technology Letters, vol. 21, no. 23, pp. 1749-1751, Dec. 2009. herein incorporated by reference], unipolar orthogonal frequency division multiplexing (U-OFDM) [D. Tsonev, S. Sinanovi´c, and H. Haas, “Novel Unipolar Orthogonal Frequency Division Multiplexing (U-OFDM) for Optical Wireless,” in Proc. of the Vehicular Technology Conference (VTC Spring), IEEE. Yokohama, Japan: IEEE, May 6-9 2012, to appear, herein incorporated by reference]. They use different properties of the OFDM frame for generation of unipolar signals, which do not require DC-biasing and achieve better power efficiency.

It is at least one object of at least one embodiment of the present invention to provide an improved or alternative communication system and detector and/or to at least partially address at least one problem with the prior art.

### STATEMENTS OF INVENTION

According to an aspect of the present invention is a method for converting a signal from a bipolar signal into a unipolar signal. The method may comprise: applying a pulse shaping filter to the bipolar signal to produce a pulse shaped bipolar signal and transforming the negative values of the pulse shaped bipolar signal to produce the unipolar signal.

The method for converting a signal from a bipolar signal into a unipolar signal may comprise or be comprised in a method for converting a discrete time signal into a continuous time signal. An input signal may comprise the discrete-time signal. The input signal may comprise the bipolar signal or the bipolar signal may be derived from the input signal. It will be appreciated that the pulse shaped bipolar signal and/or the unipolar signal may comprise the continuous time signal.

The continuous time signal may comprise an analogue signal. The discrete time signal may comprise a digital signal, e.g. a binary signal.

Advantageously, the pulse shaping filter may comprise or apply a root-raised-cosine filter. Optionally, the filter may comprise or apply a sinc function or a raised-cosine filter or a Gaussian function. The pulse shaping filter may comprise or apply a band limited filter or pulse shape. The pulse shaping filter may comprise or apply a non-causal filter, pulse shape or response.

The bipolar signal may comprise or be representative of or be derived from any suitable modulation technique that produces a real and bipolar signal, such as an orthogonal frequency division multiplexing (OFDM) signal. The bipolar signal and/or the shaped bipolar signal and/or the unipolar signal may comprise a plurality of frames.

Optionally, the transforming of the negative values may be done in the digital domain (e.g. at a digital signal processor). Alternatively, the transforming of the negative values may be done in the analogue domain (e.g. after a Digital-to-Analogue Converter). Advantageously, the transforming of the negative values may be carried out after the pulse shaping operation. The transforming of the negative values of the pulse shaped bipolar signal may comprise clipping. The method may comprise using, or using some steps of, an asymmetrically clipped optical OFDM (ACO-OFDM), pulse amplitude modulated discrete multitone modulation (PAM-DMT), unipolar orthogonal frequency division multiplexing (U-OFDM) or Flip-OFDM technique. The application of these techniques may produce a unipolar signal.

The frames may comprise at least one guard interval and preferably two or more guard intervals. The guard interval(s) may comprise a prefix, preferably a cyclic prefix, which may be provided before or at the start of at least one and preferably each frame. The guard interval(s) may comprise a suffix, preferably a cyclic suffix, which may be provided after or at the end of at least one and preferably each frame. The suffix may have a length N_{cp}^{p} that is dependent on the impulse response of the pulse shaping filter. Advantageously, the frames may comprise both cyclic prefix and cyclic suffix guard intervals.

According to an aspect of the present invention is a signal processor configured to convert a signal from a bipolar signal into a unipolar signal. The signal processor may be configured to apply a pulse shaping filter to the bipolar signal to produce a pulse shaped bipolar signal and transforming the negative values of the pulse shaped bipolar signal to produce the unipolar signal.

The signal processor may comprise at least one signal input for receiving an input signal. The signal processor may comprise at least one modulator for modulating the signal. The signal processor may comprise a pulse shaper for shaping the signal. The signal processor may comprise a transformation module for transforming the pulse shaped bipolar signal into a unipolar signal. The transformation module may be configured to perform clipping, biasing or the like.

The signal processor may be configured to convert a discrete time signal into a continuous time signal. The input signal may comprise the discrete-time signal. The input signal may comprise the bipolar signal or the bipolar signal may be derived from the input signal. It will be appreciated that the pulse shaped bipolar signal and/or the unipolar signal may comprise the continuous time signal.

The input signal may comprise a bit stream. The at least one of the one or more modulators may be configured to apply an amplitude modulation scheme, preferably a quadrature amplitude modulation (QAM) scheme such as M-QAM. At least one of the one or more modulators may comprise an OFDM modulator. The OFDM modulator may be configured to output the bipolar signal.

The signal processor may be configured to implement the signal conversion method as described above.

According to an aspect of the present invention is a transmitter comprising a signal processor and at least one transmitter element for transmitting a processed signal received from the signal processor. The signal processor may be configured to convert a signal from a bipolar signal into a unipolar signal, the signal processor being configured to apply a pulse shaping filter to the bipolar signal to produce a pulse shaped bipolar signal and transforming the negative values of the pulse shaped bipolar signal to produce the unipolar signal.

The signal processor may comprise at least one signal input for receiving an input signal and/or at least one modulator for modulating the signal and/or a pulse shaper for shaping the signal and/or a transformation module for transforming the pulse shaped bipolar signal into a unipolar signal. The transformation module may be configured to perform clipping, biasing or the like.

The signal processor may comprise the signal processor as described above. The transmitter may be configured to implement the signal conversion method described above.

The at least one transmitter element may comprise an intensity modulated transmitter element. The at least one transmitter element may comprise an optical transmitter element, such as an LED or laser diode. The transmitter may be an optical transmitter for an optical communications system.

The input signal may comprise a bit stream. The at least one of the one or more modulators may be configured to apply an amplitude modulation scheme, preferably a quadrature amplitude modulation (QAM) scheme such as M-QAM. At least one of the one or more modulators may comprise an OFDM modulator. The OFDM modulator may be configured to output the bipolar signal.

According to an aspect of the present invention is a receiver comprising a signal processor and at least one receiver element for receiving a processed signal, the signal processor comprising a filter for filtering a signal, at least one demodulator for demodulating a signal and an output for outputting an output signal, wherein the receiver element is configured to receive a unipolar signal and the signal processor is configured to convert the unipolar signal into a bipolar signal.

The at least one receiver element may comprise a direct detection receiver element. The at least one receiver element may comprise an optical receiver element, such as a photodiode, CCD or CMOS detector. The receiver may be a receiver for an optical communications system.

The at least one of the one or more demodulators may be configured to apply an amplitude demodulation scheme, preferably a quadrature amplitude demodulation (QAM) scheme such as M-QAM. At least one of the one or more demodulators may comprise an OFDM demodulator. At least one of the demodulators may be configured to output a bit stream. The filter may comprise a match filter. The receiver may comprise a sampler. The receiver may comprise an additive white Gaussian noise unit.

According to an aspect of the present invention is a communications system, the communications system comprising at least one transmitter for transmitting a signal and at least one receiver for receiving the signal.

The communication system may be configured to convert a bipolar signal into a unipolar signal for transmission and/or convert a received unipolar signal into a bipolar signal. The communications system may be configured to convert a discrete time signal into a continuous time signal at a signal processor or transmitter and/or be configured to convert a continuous time signal into a discrete time signal at a receiver.

The communications system may comprise a transmitter as described above and/or a receiver as described above and/or the signal processor as described above. The communications system may be configured to implement the signal conversion method as described above.

According to an aspect of the present invention is a computer program product for implementing the signal conversion method and/or transmitter and/or receiver and/or communications system and/or signal processor as described above.

According to an aspect of the invention is a transmission system for transmitting data as part of a communications system, the data comprising a plurality of data symbols or elements, the transmission system being configured to divide the data into at least a first data portion and a second data portion, wherein the first data portion is communicated by transmitting signals in selected carrier channels, wherein the transmission system is configured to encode at least one data symbol or element by selecting a relative order of at least one first carrier channel having a first operational state and at least one second carrier having a second operational state.

One of the that or second operational states may comprise a signal being carried by the associated carrier channel. The other of the first or second operational states may comprise an inactive and/or unused and/or zero state carrier channel or transmitting a signal at a level that is lower or otherwise distinguishable from the signals of the first state.

The data symbol or element may comprise at least one bit of binary data.

The signals being carried by the carrier channels may comprise a modulated or encoded signal, such as a M-QAM signal. At least one of the signals being carried by the carrier channels may modulate or encode the second data portion.

The carrier channels may be sequential.

For example, one of a data bit 0 or 1 may be encoded by providing a signal on a preceding or first carrier channel of a pair of carrier channels and leaving a following or second carrier channel of the pair of carrier channels inactive. The other of data bits 1 or 0 may be encoded by leaving the preceding or first carrier channel of the pair of data carrier channels inactive and providing a signal on the following or second carrier channel.

At least one and optionally each carrier channel may comprise a different frequency band or channel. At least one and optionally each carrier may comprise a different time slot. At least one and optionally each carrier may comprise a different spatial position, for example, or a transmitter element such as an LED.

The number of first carrier channels may be equal to the number of second carrier channels.

The encoding may be based on a predetermined look-up table or the like. The encoding may be based on an algorithm that matches blocks of bits to a combination of carrier channels within a sub-block of the total number of carrier channels.

The transmitter may be configured to convert at least one bipolar signal into one or more unipolar signals by transmitting only the absolute values of a bipolar signal and encoding the signs separately. The signs may be encoded within the same frame, preceding frames, or following frames. The signs may be encoded within the relative order of the carrier channels, which may be frequency, time, or spatial carrier channels, and may be encoded as symbols that modulate the carrier channels, or may be encoded in a separate modulation scheme on a separate part of the transmission stream. The signs may also be conveyed to the destination on a separate transmission channel, or a separate part of the communication system.

Signs, phase or other information may be transmitted using spatial and/or spectral modulation. For example, a first transmitter element, such as a first LED, may be activated when the sign is positive, and a second transmitter element, such as a second LED, may be activated when the sign is negative. Similarly, at least a pair of LEDs having different colours or an LED configured to produce two or more colours (e.g. by varying it's temperature) may be provided and the respective differing colours may be associated with positive or negative signs respectively.

These techniques used to transmit signs need not be limited to transmission of signs, e.g., they could be used to transmit other data such as phase information. For example, phase information may be encoded in the spatial domain, which may comprise use of a transmitter with a plurality of transmitter elements, such as LEDs, wherein use of selected transmitter element may be indicative of a different phase. For example, the first transmitter element may be indicative of a first phase, such as 45°, use of the second transmitter element may be indicative of a second phase, such as 90°, use of the third transmitter element may be indicative of a third phase such as 135° and use of the fourth transmitter element may be indicative of a fourth phase such as 0°. Whilst it will be appreciated that the above example uses four phases and transmitter elements for use with QPSK signals, it will be appreciated that other encoding schemes and numbers of transmitters/phases may be used.

In a specific but non-limiting example, the transmitter may be configured to convert at least one multipolar signal into two or more unipolar signals. The unipolar signals may comprise, for example, time resolved signals/signals modulated in the time domain and/or frequency resolved signals/signals modulated in the frequency domain and/or spatially resolved signals/signals modulated in the spatial domain. At least one of the unipolar signals may be inactive or have zero intensity or at least an intensity that is distinguishable from any signal intensity used in at least one other of the unipolar signals. At least one other of the unipolar signals may have a magnitude that is equal or equivalent to a magnitude of the multipolar signal. The transmitter may be configured to encode a sign (e.g. positive or negative) of the multipolar signal by using a relative order of at least two of the converted unipolar signals. For example, if the unipolar signal having the same magnitude as the original signal is provided first and the inactive signal is provided second, then this may be representative of a positive signal having a magnitude equal to the first converted signal and if an inactive or zero converted signal is provided first and a converted signal having the magnitude of the original signal is provided second, then this may be representative of a negative signal having a magnitude that is equivalent to the magnitude of the second signal. It will be appreciated that the orders used to represent positive and negative signals may be reversed if preferred.

According to an aspect of the invention is a method for transmitting data in a communications system, the data comprising a plurality of data symbols or elements, the method comprising dividing the data into at least a first data portion and a second data portion, communicating the first data portion by transmitting signals in selected carrier channels, wherein the relative order of at least one first carrier channel having a first operational state and at least one second carrier having a second operational state is representative of each data symbol or element of the first data portion.

The method may comprise using a transmitter as described above.

According to an aspect of the invention is a communications system comprising a transmission system as described above and a receiver for receiving a data signal from the transmission system, wherein the receiver is configured to determine the relative order of at least one carrier channel having a first operational state and at least one second carrier channel having a second operational state in order to determine at least a portion of the data.

According to art aspect of the present invention is a method of communicating data that comprises a plurality of data symbols or elements, the method comprising:

dividing the data into at least a first data portion and a second data portion, communicating the first data portion by transmitting signals in selected carrier channels, wherein the relative order of at least one first carrier channel having a first operational state and at least one second carrier having a second operational state is representative of each data element or symbol of the first data portion;

receiving the signal from the transmission system, determining the relative order of the at least one carrier channel having a first operational state and the at least one second carrier channel in order to determine at least the first portion of the data.

The method may comprise a method as described above and/or comprise use of a transmission system as described above and/or a communications system as described above.

According to an aspect of the invention is a transmitter and/or encoder for transmitting and/or encoding at least one bipolar signal, the transmitter and/or encoder being configured to encode a magnitude or absolute value of the at least one bipolar signal into at least one unipolar signal and further configured to encode and/or transmit a sign or phase of at least one bipolar signal separately and/or differently to the corresponding magnitude or absolute value of the at least one bipolar signal.

The signs or phases of the at least one bipolar signal may be encoded within the same frame, preceding frames, or following frames. The signs or phases may be encoded within the relative order of carders that carry the unipolar signals, which may be frequency, time, or spatial carriers, and may be encoded as symbols that modulate the carders, or may be encoded in a separate modulation scheme on a separate part of the transmission stream. The signs or phases may also be conveyed to the destination on a separate transmission channel, or a separate part of the communication system.

Optionally but not essentially, the transmitter and/or encoder may be configured to encode each bipolar signal into two or more corresponding unipolar signals, which may be encoded on first and second carrier channels. The transmitter may be configured to encode the sign or phase of the bipolar signal based on the relative order of the first and second operational states. One of the first or second operational states may be indicative of the magnitude or absolute value of the bipolar signal.

According to an aspect of the present invention is a receiver for receiving a signal from a transmission system, the receiver being configured to receive at least one unipolar signal from the transmission system, determine a magnitude of at least one bipolar signal from the at least one unipolar signal and determine a sign or phase of the at least one bipolar signal, wherein the sign or phase of the at least one bipolar signal is encoded and/or transmitted separately and/or differently to the corresponding magnitude of the at least one bipolar signal.

The receiver may be configured to reconstruct the bipolar signal using the determined magnitude and sign or phase of the bipolar signal.

The signs or phases of the at least one bipolar signal may be encoded within the same frame, preceding frames, or following frames. The signs or phases may be encoded within the relative order of the carriers, which may be frequency, time, or spatial carriers, and may be encoded as symbols that modulate the carriers, or may be encoded in a separate modulation scheme on a separate part of the transmission stream. The signs may also be conveyed to the destination on a separate transmission channel, or a separate part of the communication system.

Optionally but not essentially, the receiver may be configured to determine the relative order of at least one carder channel having a first operational state and at least one second carrier channel having a second operational state in order to determine the sign or phase of the bipolar signal based on the relative order of the first and second operational states.

The receiver may be configured to receive a signal from a transmission system as described above and/or be configured for use in a communications system as described above.

According to an aspect of the present invention is a method for decoding a signal received from a transmission system, the method comprising receiving at least one unipolar signal from the transmission system, determining a magnitude of at least one bipolar signal from the at least one unipolar signal and determining a sign or phase of the at least one bipolar signal, wherein the sign or phase of the at least one bipolar signal is encoded and/or transmitted separately and/or differently to the corresponding magnitude of the at least one bipolar signal.

The method may comprise receiving a signal sent using the method as described above or from a transmission system as described above.

According to an aspect of the present invention is a method of converting at least one bipolar signal into at least one unipolar signal, the method comprising determining a sign or phase of at least one component of the bipolar signal, encoding and/or transmitting the absolute values of a bipolar signal in the unipolar signal and encoding and/or transmitting the sign or phase of the at least one bipolar signal separately and/or differently to the encoding and/or transmitting the absolute values of a bipolar signal.

For example, the method may comprise converting at least one of the components of the multipolar signal into corresponding first and second unipolar signal components. The first and second unipolar signal components may have different amplitudes or magnitudes. The order of the first and second unipolar signal components may be dependent on the sign or phase of the corresponding multipolar signal component.

At least one of the first or second unipolar signal components may be indicative of the intensity or magnitude of the corresponding multipolar signal component. The other of the first or second multipolar signal components may have an amplitude or magnitude of zero and/or comprise an inactive or empty carrier channel.

The order of the first and second unipolar signal components over time may be dependent on the sign or phase of the corresponding multipolar signal component. The first and second unipolar signal components may be resolved and/or separated in the time, frequency and/or spatial domains.

According to an aspect of the present invention is a computer program product adapted to implement the apparatus or method of one or more of the preceding aspects.

According to an aspect of the present invention is a carrier medium comprising the computer program product described above or a programmable apparatus when programmed with the computer program product described above.

It will be appreciated that features analogous to those described above in relation to any of the above aspects may be individually and separably or in combination applicable to any of the other aspects.

Apparatus features analogous to those described above in relation to a method and method features analogous to those described above in relation to an apparatus are also intended to fall within the scope of the present invention.

### DESCRIPTION OF THE DRAWINGS

Examples of the present invention will be described in relation to the following drawings:

Various Figures depicting, illustrating and/or useful for understanding the present invention are embedded in the appended text.

FIG. 1 is an illustration of a spatial modulation system;

FIG. 2 is a plot of bandwidth efficiency and dimming for a spatial modulation system having thirty two transmitter elements;

FIG. 3 is an illustration of a prior art SIM-OFDM method;

FIG. 4 is a plot showing the performance differences between SIM-OFDM and OFDM for differing QAM constellation sizes;

FIG. 5 illustrates an encoding or modulation method;

FIG. 6 shows a specific example of the method of FIG. 8, where the total number of carriers is six and the number of active carriers is three;

FIG. 7a shows an OFDM signal in the time domain;

FIG. 7b shows the OFDM signal of FIG. 10a that has been subjected to a DC shift;

FIG. 7c shows the OFDM signal of FIG. 10a transformed using the method of an embodiment of the present invention;

FIG. 8 shows the performance of the method illustrated in FIG. 8 relative to OFDM;

FIG. 9 shows the performance of the method illustrated using FIG. 10c relative to ACO and OFDM for bipolar signals as a function of the electrical signal to noise ratio;

FIG. 10 shows the performance of the method illustrated using FIG. 10c relative to ACO and DCO for unipolar signals as a function of the electrical signal to noise ratio;

FIG. 11 shows the bit error rate performance of the method illustrated using FIG. 10c relative to ACO and DCO as a function of the optical signal to noise ratio;

FIG. 12 is a schematic of an OFDM based communications system;

FIG. 13 is a schematic of an OFDM signal;

FIG. 14 shows a bipolar (unclipped) OFDM signal;

FIG. 15 shows a unipolar (clipped) OFDM signal cupped using Asymmetrically Clipped OFDM (ACO-OFDM);

FIG. 16 shows a unipolar signal;

FIG. 17 shows a unipolar digital signal combined with bipolar pulse shape;

FIG. 18(a) shows a bipolar signal;

FIG. 18(b) shows the signal of FIG. 18(a) after being made unipolar by application of a bias;

FIG. 19(a) shows distortion in a 16-QAM constellation after clipping negative values of the continuous time signal;

FIG. 19(b) shows distortion in the 4-PAM constellation after clipping negative values of the continuous time signal;

FIG. 20 shows a discrete bipolar signal that has been shaped with bipolar pulse shape;

FIG. 21 shows the signal of FIG. 20 that has been clipped after shaping;

FIG. 22 shows the distortion the signal of FIG. 21;

FIG. 23 illustrated bipolar signal having both a cyclic suffix and a cystic prefix;

FIG. 24 shows distortion for: (a) 16-QAM ACO-OFDM with a prefix only. (b) 4-PAM PAM-DMT with a prefix only. (c) 16-QAM U-OFDM with a prefix only. (d) 16-QAM ACO-OFDM with a prefix and a suffix. (e) 4-PAM PAM-DMT with a prefix and a suffix. (f) 16-QAM U-OFDM with a prefix and a suffix, all of which are obtained with a root-raised cosine flier with a rolloff factor of 0.5;

FIG. 25 is equivalent to FIG. 24 by obtained using a root raised cosine filter with a rolloff factor of 0.1;

FIG. 26 shows effect of clipping scheme, prefix, suffix and biasing on the variation of Bit Error Rate (BER) with Signal to Noise Ratio (SNR);

FIG. 27 shows an unclipped bipolar signal;

FIG. 28 shows the signal of FIG. 27 after having been clipped using PAM-DMT;

FIG. 29 shows an unclipped bipolar signal;

FIG. 30 shows a unipolar signal after having been clipped using a Flip-OFDM method; and

FIG. 31 shows (a) discrete bipolar ACO-OFDM signal, shaped with a root-raised cosine filter. (b) signal from (a), made unipolar through clipping.

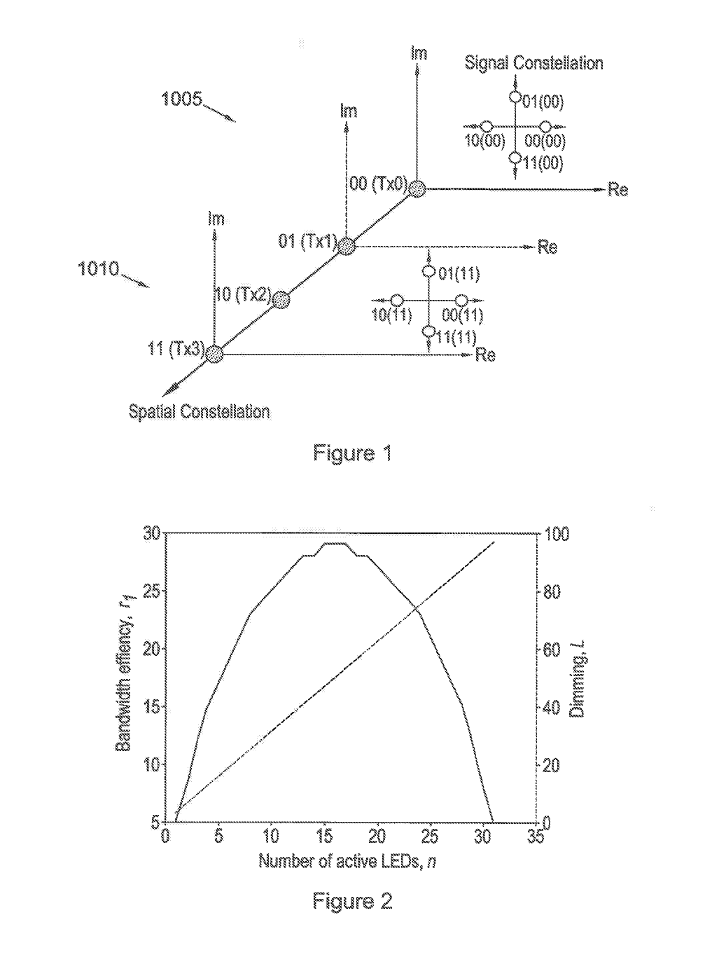

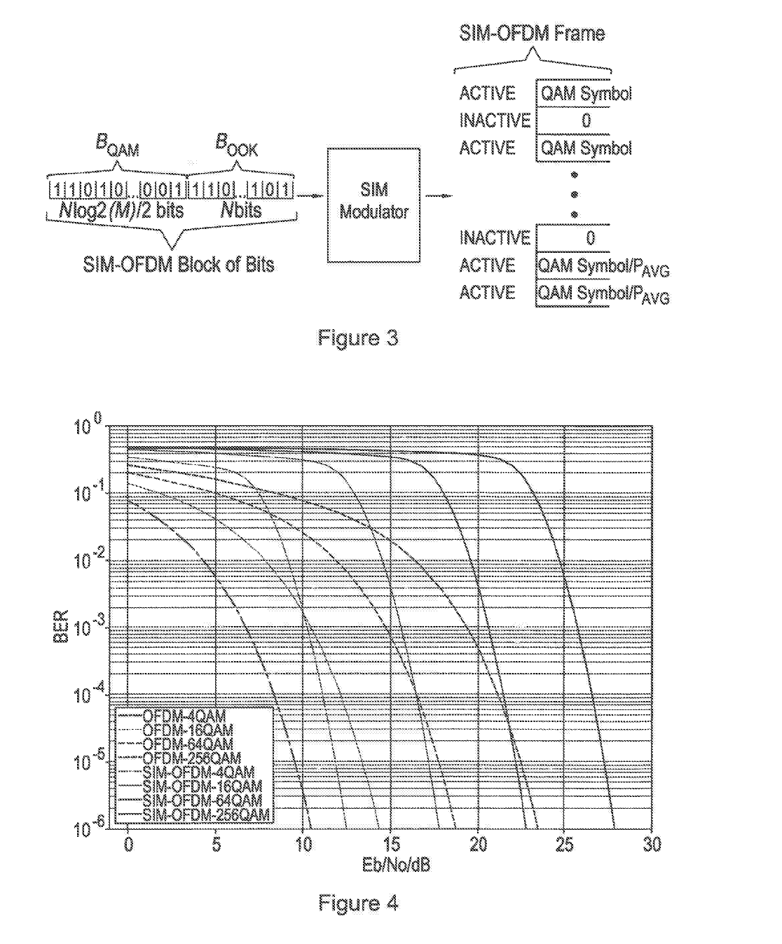

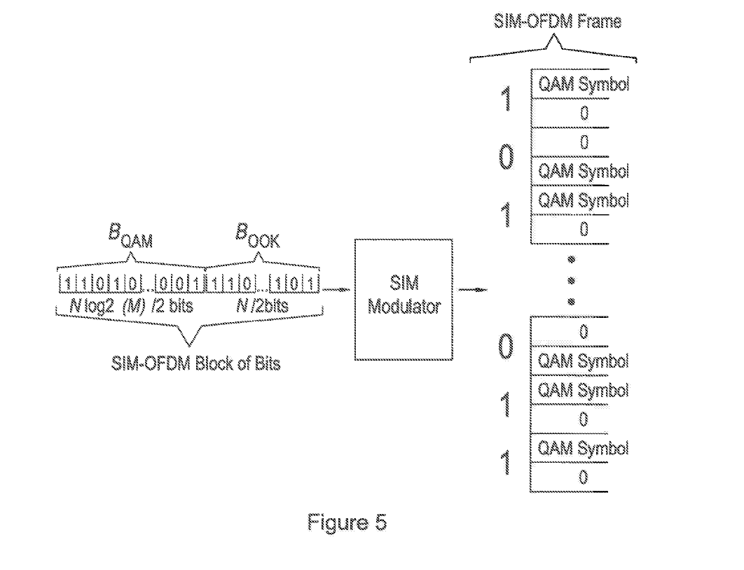

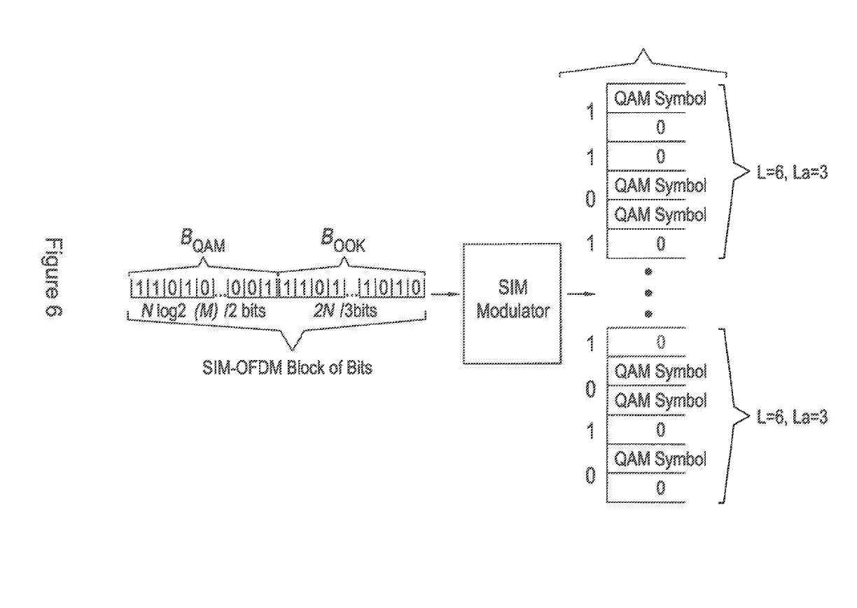

### DETAILED DESCRIPTION OF THE DRAWINGS

Some embodiments of the present invention and information useful in understanding the present invention are described in the attached Appendix A.

Some additional material describing embodiment of the invention and information useful in understanding the invention is described in Appendix B.

Some optional features that may be used in or with any of the methods and apparatus' described above or in the attached Appendices A and B are described below.

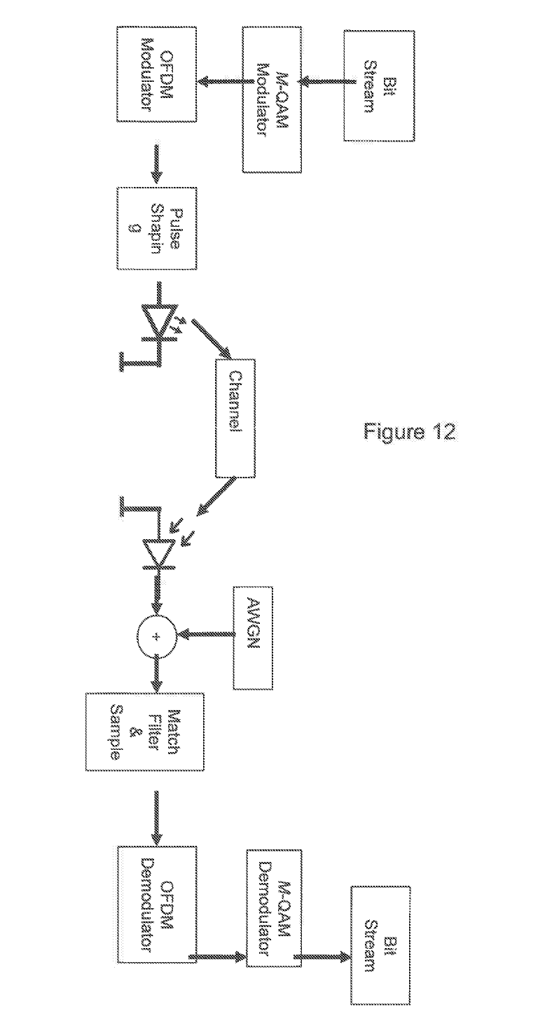

At least one embodiment of the present invention comprises a transmitter, having at least one radiation emitter or transmitter element for emitting a signal and a processor for modulating the radiation emitter(s) in order to encode data comprising at least one data symbol or element. Examples of suitable transmitters and/or receivers are shown, e.g. in FIG. 12. Preferably but not essentially, the transmitter is an optical transmitter and the at least one radiation emitter comprises optical transmitter such as an LED.

The signal from the transmitter is received by a receiver, comprising at least one corresponding receiving element, such as a CMOS or CCD detector or a photodiode array, and a processor for extracting the data from the received signal.

As discussed above, communications systems can be configured to transmit data using one or more of various known modulation or encoding schemes, such as OFDM and SIM-OFDM.

The authors have found by studying the SIM-OFDM method in the presence of Additive White Gaussian Noise that the expected improved system performance compared to conventional OFDM modulation techniques is not achievable, as can be seen from FIG. 4. Without wishing to be bound to any particular theory, there may be various possible reasons for this. First, using coherent on off keying (OOK) detection requires a threshold, whose level should not be higher than the power of the M-QAM symbol closest to 0. Otherwise, symbols whose power is lower than the threshold will not be detectable even under high SNR conditions and a constant BER floor will be reached above zero. The low threshold level does not allow the OOK scheme to take full advantage of the high power in each carrier for higher order M-QAM. Second, in order to correctly demodulate a given M-QAM symbol, it is not only necessary to correctly detect the state (i.e. active or inactive) of its carrier, but also the states of all carriers before it. This is necessary because incorrect detection of a carrier state causes the bits in the second sub-block (B_{QAM}) to be misplaced and become out of sequence, which completely destroys the M-QAM information in any subsequent active carriers.

One possible solution would be to transmit the exact number of excess carriers, Nₑₓ=Nₐ−N/2, separately for each frame, just like the majority bit type is sent to the destination, where Nₐ represents the number of active carriers. That way, instead of using a threshold for on-off keying (OOK) detection, the number of active carriers Nₐ with the highest power can be taken as active for each frame, provided that Nₑₓ is securely transmitted to the destination. This technique leads to better performance, but is still insufficient. If ail active carriers are used to transmit M-QAM symbols, the spectral efficiency is slightly increased to:

$$\frac{E [ {N}_{a} ]}{N} {log}_{2} ( M ) + 1 \frac{bits}{carrier}$$

where E[Nₐ] stands for the statistical expectation of Nₐ.

FIG. 8 illustrates an encoding or modulation method according to an embodiment of the present invention. As in SIM-OFDM, data is split into at least two portions, wherein a first portion (B_{OOK}) of the data is encoded by transmitting signals using selected carrier channels, wherein the remaining (i.e. non-selected carrier channels) are left inactive and/or at zero or low intensity. A second portion (B_{QAM}) of the data is encoded by modulating the active carrier channels, for example, by using amplitude modulation techniques known in the art such as M-QAM.

However, instead of using every carrier state to encode a bit (or other data element), as is the case in SIM-OFDM, the present invention uses the states of two or more carriers, in this case, a carrier pair. The processor of the transmitter is configured to encode bits in the first data portion B_{OOK} by selecting which carrier from the pair is active. In this case, when a data bit 1 is encountered, the first or preceding carrier is selected to be active (i.e. a signal is provided/carried on the first or preceding carrier) and the second or following carrier is left inactive. When a data bit 0 is encountered, the first or preceding carrier is left inactive and the second or following carrier is made active (i.e. a signal is provided on it). The processor of the transmitter is configured to encode the bits in the second data portion B_{QAM} by modulating all of the active carriers using an modulation scheme such as M-QAM, so that each active carrier channel encodes a data symbol or data element of the second data portion B_{QAM} in the form of an M-QAM symbol.

At the receiver, once the signal is received, the processor of the receiver is configured to process the carriers in the received signal two at a time and the carrier states, active or inactive, are determined by comparing the relative power levels of each carrier in the pair. The carrier with more power is considered active. Based on the determined states of the carrier pairs, the first data portion B_{OOK} is determined.

Afterwards, all of the active carriers are demodulated according to the associated demodulation scheme (in this case M-QAM) and the second portion of the data B_{QAM} is reconstructed.

In this approach, it is not necessary to determine and transmit majority bit type, as the determination of which carrier is active is based on a comparison of a pair of carriers and not an individual carrier with a threshold. Using this technique, the overall spectral efficiency is slightly reduced to:

$$\frac{{log}_{2} ( M )}{2} + \frac{1}{2} \frac{bits}{carrier}$$

However, any error in the detection of the carrier states influences only the M-QAM symbol encoded in the relevant carrier.

Optionally, the concept can be extended to using more than two carriers at a time to represent bits from the first data portion B_{OOK}. For example, six carriers can be used, with three carriers being set as active and the rest of the carriers being set as inactive. In this example, there are 6 l/3 l·3 l=20 possible combinations to represent bits. This means that a total of four bits (2⁴=16<20) can be encoded in 6 carriers' states when three are active, as depicted in FIG. 6. The encoding can be based either on a predetermined table or an algorithm that matches blocks of bits to a combination of Lₐ active carriers in a sub-block of L carriers in total. The spectral efficiency is thereby increased.

Extending this to a group of L carriers of which Lₐ of the carriers are set as active, the spectral efficiency of the system becomes:

$$\frac{{L}_{a} {log}_{2} M}{L} + \frac{⌊ {log}_{2} ( \frac{L !}{{L}_{a} ! ( L - {L}_{a} ) !} ⌋}{L} \frac{bits}{carrier}$$

The BER performance can get worse as L increases, since the negative effects described for the original SIM-OFDM method appear inside each group of L carriers. As Lₐ approaches L, the spectral efficiency of the system gets closer to that of conventional OFDM. As L approaches N, and Lₐ approaches 1, the spectral efficiency of the system starts to resemble that of Pulse Position Modulation (PPM). As L approaches N, and Lₐ approaches N/2, the spectral efficiency of the system gets closer to that of the former SIM-OFDM scheme. In any case, the present invention has an advantage over SIM-OFDM because it keeps a constant number of active carriers and requires no majority bit type information.

In cases where inter-symbol interference is no an issue, OFDM does not provide particular advantages to the system. In this case, the concept can be realized in the time domain in exactly the same manner, where the carriers would correspond to time samples rather than frequency carriers.

Use of the above method may result in a number of advantages over the existing SIM-OFDM technique. For example, the number of active carriers, Nₐ is known at each instant, so it need not be transmitted and the usage of a threshold is not necessary. In addition, the number of active and inactive samples is the same in each frame, so majority bit type does not need to be relayed to the destination. Furthermore, false detection of a carrier state influences only the M-QAM symbol it encodes and the error does not propagate in the rest of the frame. Advantageously, the bit error rate vs.

$$\frac{{L}_{a} {log}_{2} M}{L} + \frac{⌊ {log}_{2} ( \frac{L !}{{L}_{a} ! ( L - {L}_{a} ) !} ⌋}{L} \frac{bits}{carrier}$$

performance is improved compared to the former SIM-OFDM scheme and in certain cases compared to conventional OFDM. Additionally, peak-to-average power ratio (PAPR) is reduced relative to the SIM-OFDM and OFDM schemes and a power efficient modulation scheme for optical wireless communication is introduced.

A comparison of the performance of a communications system that operates using the above encoding method relative to a corresponding system using the conventional OFDM method in the presence of Additive White Guassian Noise (AWGN) is illustrated in FIG. 8. As can be clearly seen from this, a system using the modulation/encoding scheme of the present invention achieves better bit error ratio results than the prior art systems under the same conditions.

Further research of the properties of SIM-OFDM based techniques by the present inventors have shown that such systems can achieve better peak-to-average power ratio (PAPR) than equivalent systems using conventional OFDM. For OFDM with square constellation M-QAM, the PAPR is calculated as:

$$\frac{N 3 ( \sqrt{M} - 1 )}{\sqrt{M} + 1}$$

A general formula for PAPR estimation is:

$$\frac{{N}_{a} 3 ( \sqrt{M} - 1 )}{\sqrt{M} + 1}$$

The PAPR depends on both the number of active carriers, expressed by Na, and the way they are modulated, expressed by the ratio:

$$\frac{3 ( \sqrt{M} - 1 )}{\sqrt{M} + 1}$$

The best PAPR is achieved using Frequency Shift Keying (FSK), since Na=1 and

$$\frac{3 ( \sqrt{M} - 1 )}{\sqrt{M} + 1} = 1.$$

The worst is achieved in the case of conventional OFDM when Na=N, and both N and M are as high as possible. An advantage of the above encoding method of the present invention over conventional OFDM and SIM-OFDM comes from the fact that in general it requires less active carriers to represent the same amount of information.

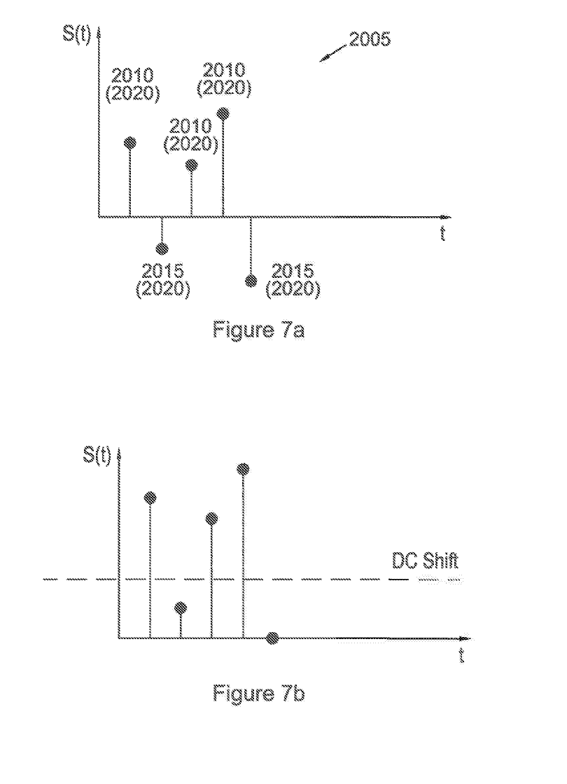

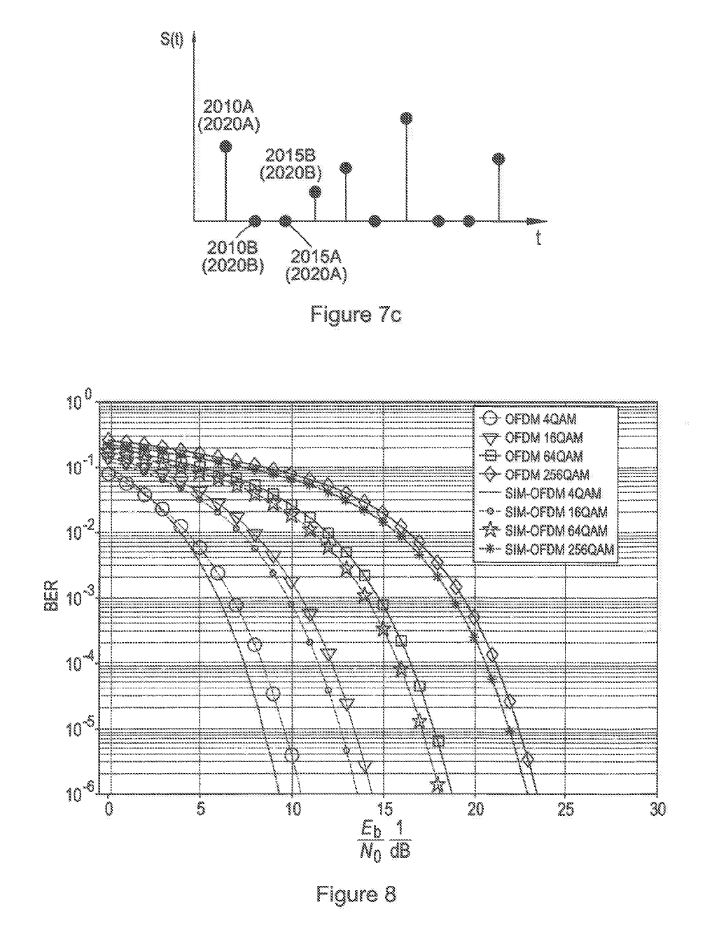

For the particular purpose of optical wireless communication using intensity modulation (IM) at the transmitter and direct detection (DD) at the receiver, another embodiment of the present invention can be realized. In optical communication systems, there is an issue with using optical communications systems to transmit bipolar data signals 2005, i.e. signals having both positive 2010 and negative 2015 signal components, as an optical transmitter such as an LED can generally only transmit positive real signal values. In OFDM, N time domain samples 2020 of a real OFDM frame with N carriers are obtained after the required modulation steps, as shown in FIG. 7a. Such a signal is made real for the purposes of IM/DD communication. Additionally, the OFDM signal can be made positive by introducing a DC shift as depicted in FIG. 7b. This approach is known as DCO-OFDM.

An alternative approach is known as ACO-OFDM in which properties of Fourier transforms are exploited so that a positive signal can be obtained in the time domain by simply ignoring (cutting off) any negative values. However, this approach has half the spectral efficiency of DCO and half the power efficiency for bipolar signals.

An embodiment of the present invention (referred to as Unipolar orthogonal frequency division multiplexing, U-OFDM, by the present inventors), provides a more elegant solution, that outperforms ACO. As shown in FIG. 7c, in the U-OFDM method according to an embodiment of the present invention, each time sample 2020 of the bipolar OFDM signal of FIG. 7a is transformed into two time samples 2020A, 2020B. If the original time sample 2020 was positive 2010, the first one 2010A of the two new time samples 2020A, 2020B is equal to the amplitude of the original time sample 2010, so it can be called an “active sample”. The second time sample 2010B is equal to zero, so it can be called an “inactive sample”. If the original time sample 2020 in the bipolar signal 2005 of FIG. 7a is negative 2015, the first one 2015A of the two new unipolar samples 2020A, 2020B is set to zero, so it can be called “inactive sample”. The second unipolar time sample 2015B is made equal to the absolute value of the original bipolar time sample 2015, so it can be called an “active sample”. This way, only the absolute value of the signal 2005 is transmitted, and the sign of each sample 2020 is encoded in the position of the “active” and “inactive” samples in each pair.

This concept can be easily extended intuitively. The essential part of the U-OFDM algorithm is in transmitting only the absolute values of the bipolar signal and the signs separately. The signs, which are effectively equal to one bit of information each, can be encoded in a variety of different ways. The case presented in FIG. 7c shows how the signs can be encoded in the relative position of the active and inactive samples. Additionally or alternatively, the signs can be encoded as bits and/or can be modulated on frequency carriers, time carriers and/or spatial carriers. They can be part of the current frame, the previous frame, the next frame, etc. They can also be conveyed to the destination on a parallel communications channel or as a separate part of the system. The modulation type can be any existing digital modulation scheme. Different approaches towards the sign encoding will lead to different spectral efficiencies and different bit error rate performances.

In the specific example given in FIG. 7c, the spectral efficiency of OFDM is halved since no bits are transmitted in the inactive sample states. This can be mitigated in a similar manner to the previously described concept by encoding more than one sample sign in a group of more than two samples. At the receiver, the maximum of each sample pair is taken. Its amplitude becomes the amplitude of the original sample, and the sign or phase is retrieved from its position in the pair. Afterwards, the demodulation process can continue as in conventional OFDM.

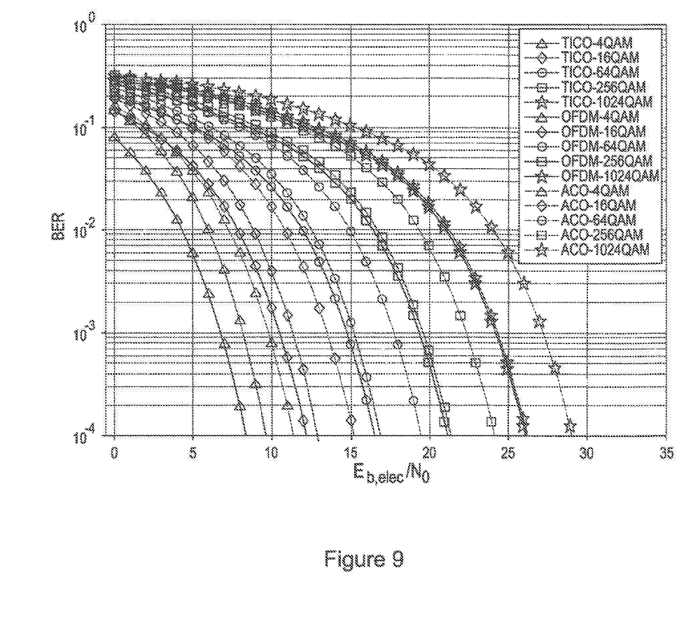

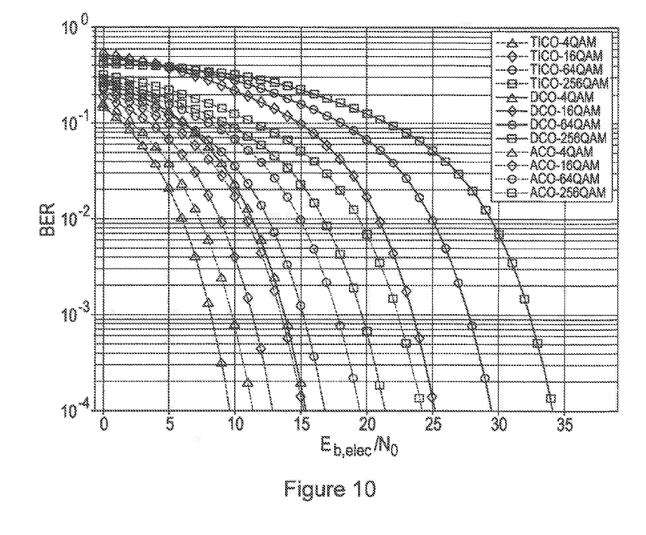

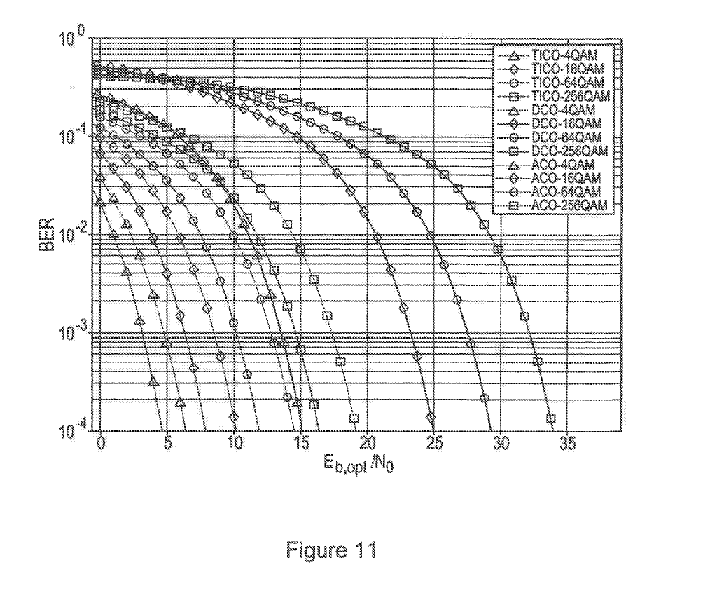

By employing the U-OFDM method described above, the performance of the communication system can be improved over communication systems that use the existing DCO-OFDM and ACO-OFDM techniques, as shown in FIGS. 9 to 11. The BER performance of U-OFDM in the presence of Additive White Gaussian Noise (AWGN) compared to pure OFDM and ACO-OFDM for bipolar signals is illustrated in FIG. 9. Performance of U-OFDM compared to DCO and ACO for unipolar signals is illustrated in FIG. 10. The biasing levels for DCO are adopted from J. Armstrong and B. J. C. Schmidt, “Comparison of Asymmetrically Clipped Optical OFDM and DC-Biased Optical OFDM in AWGN” IEEE Communication Letters 12(5):343-345, May 2008, such that no noticeable distortion is experienced in the BER curves due to signal clipping. FIG. 11 presents the comparison between U-OFDM, ACO and DCO for optical SNR introduced in the above article by Armstrong et. al. for the purpose of comparing optical efficiency of the modulation schemes.

As a summary example of an embodiment of the present invention, two copies of a bipolar signal are made. The bipolar signal is made up of a plurality of samples/portions. The first copy is kept in its original form. Samples of the second signal are switched in polarity (multiplied by −1 so that positive become negative and negative become positive). Then the negative samples in both copies are clipped. In this way, the first copy retains the original positive samples and substitutes the negative samples with zeros. The second copy retains the original negative samples as positive samples and substitutes the original positive samples with zeros. Both copies are now unipolar.

The copies can be transmitted in two separate time slots, streams, or divisions of other transmission mechanisms. At the receiver, the original signal can be reconstructed from the first and second copy after both are received, for example, by simple subtraction of the second signal copy from the first one. In this way, positive samples of the first signal copy will stay unaltered and positive samples of the second signal copy will shift polarity again to become negative samples. Of course, the zero samples will have no influence on any of the reconstructed samples since adding or subtracting a zero does not introduce a change.

Alternatively, samples in both signal copies could be examined in corresponding pairs (e.g. the first sample of the first copy is compared with the first sample of the second copy, the second sample of first copy is compared with the second sample of the second copy, and so on) to determine whether the original sample is contained in the first or the second copy (e.g. the value of a sample in one copy will be zero whilst the value in the corresponding sample in the other copy will be a positive number). In this way, the value and sign associated with the original sample can be determined. Since there is noise present at each sample, an example of a method for determining which copy holds a sample and which copy holds a zero is to take the higher value of the two as the sample an to consider the other (lower) one as a zero. In that way, zero samples can be disregarded instead of added to the “active” samples, and ideally the noise power could be reduced by half compared to the other approach.

Importantly, techniques such as the above comprise the division of an original sample into negative and positive samples in two separate unipolar information sequences which can be recombined later without breaking the original frame structure.

Discrete time-domain samples need to be mapped to continuous time-domain pulse shapes in order to obtain an analog signal suitable for modulation of a device such as a LED, as shown in FIG. 12.

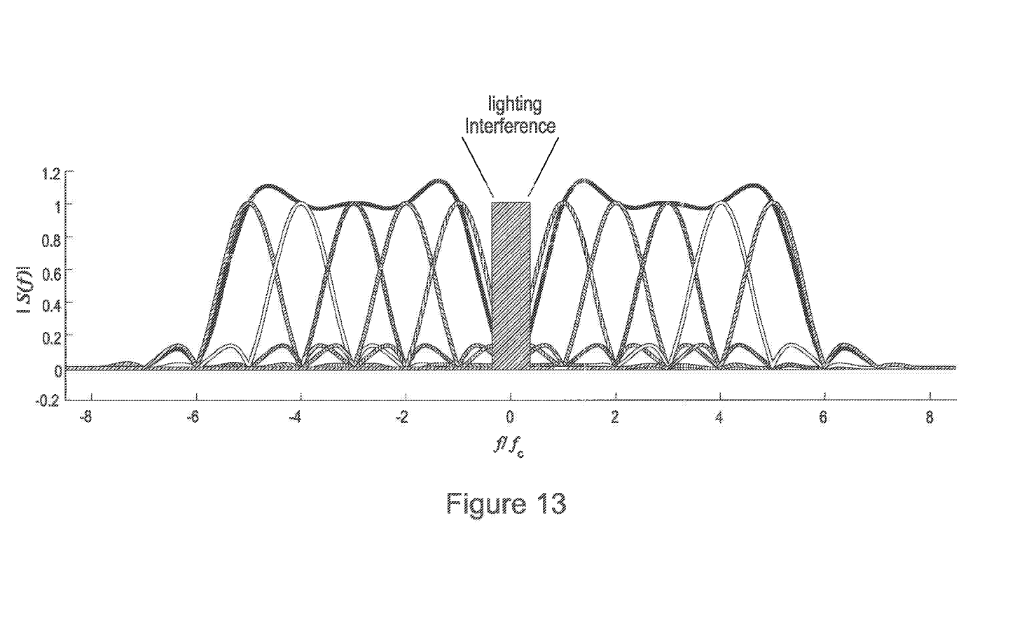

As shown in FIG. 13, real unipolar signals are required for IM/DD systems. Real Signals through Hermitian symmetry in frequency: S(f)=S*(−f). Unipolar signals are obtained in a variety of ways: DCO-OFDM, ACO-OFDM, PAM-DMT, U-OFDM, Flip OFDM, etc.

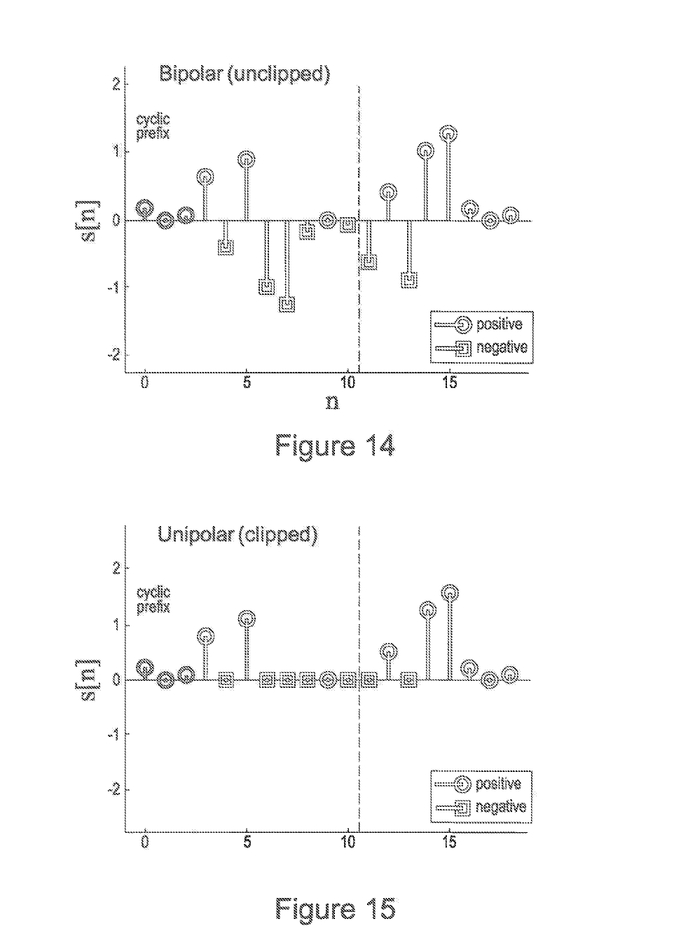

Only odd carriers are modulated. This leads to a symmetry in time domain: s[n]=−s[n+N/2] (Armstrong at al., 2006), N=number of carriers/number of FFT points, s[n]=time domain signal (see FIGS. 14 and 15).

Odd carriers only contain information <=> s[n]=−s[n+N/2], whilst even carriers only contain information <=> s[n]=s[n+N/2]. CLIP(s[n])=(s[n]+|s[n]|)/2. This representation is important. In ACO-OFDM, s[n]=−s[n+N/2]=>|s[n]|=|s[n+N/2]|. Therefore, distortion from dipping falls only on the even subcarriers.

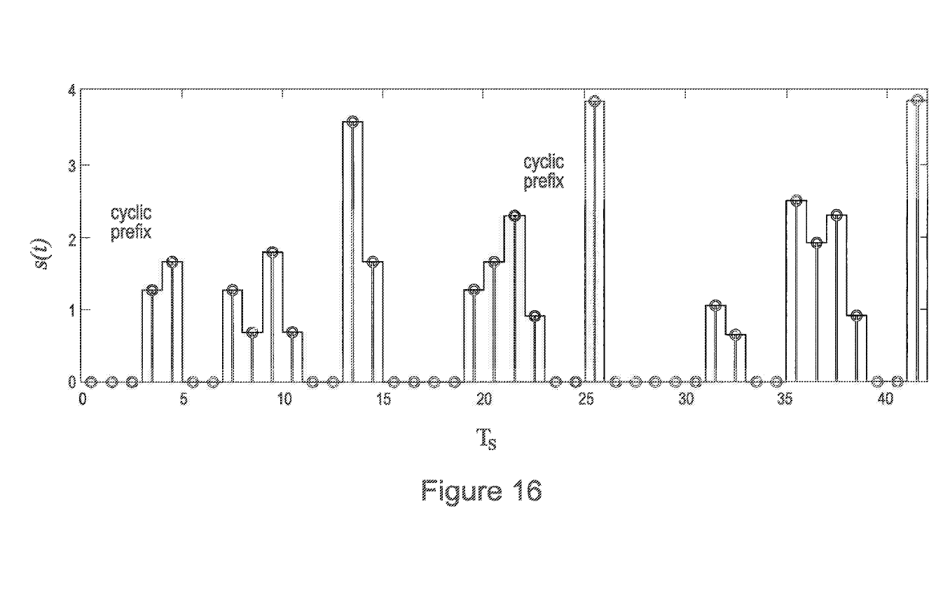

In going from the digital to analog domains, samples are represented by pulse shapes, as shown in FIG. 16. Different pulse shapes have different time and frequency characteristics.

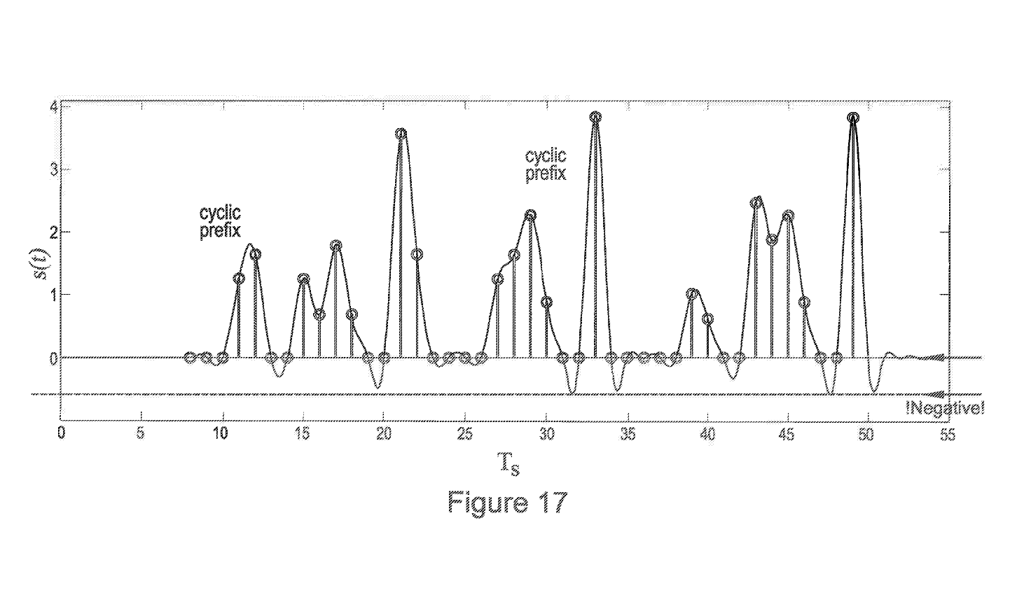

Unipolar digital signals combined with unipolar pulse shapes produce unipolar analog signals. Unipolar digital signals combined with bipolar pulse shapes produce bipolar analog signals, as shown in FIG. 17.

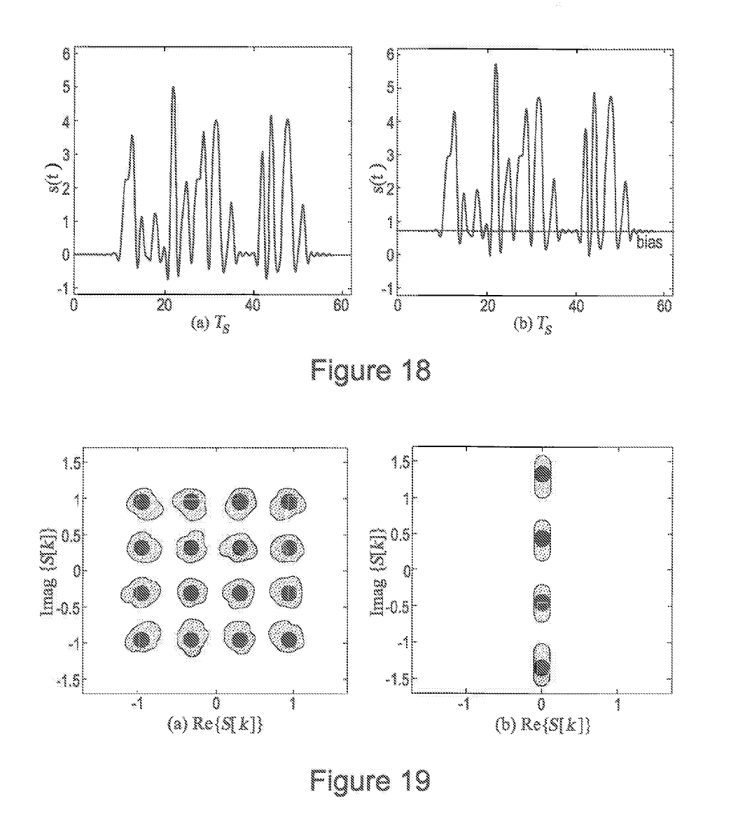

Bipolar analog signals can be made unipolar by introducing a bias shown in FIG. 18. Bias increases power dissipation.

Most of the analog signal is positive, so the negative values could be ignored (clipped). This, however, introduces distortion and out-of-band interference, as shown in FIG. 19.

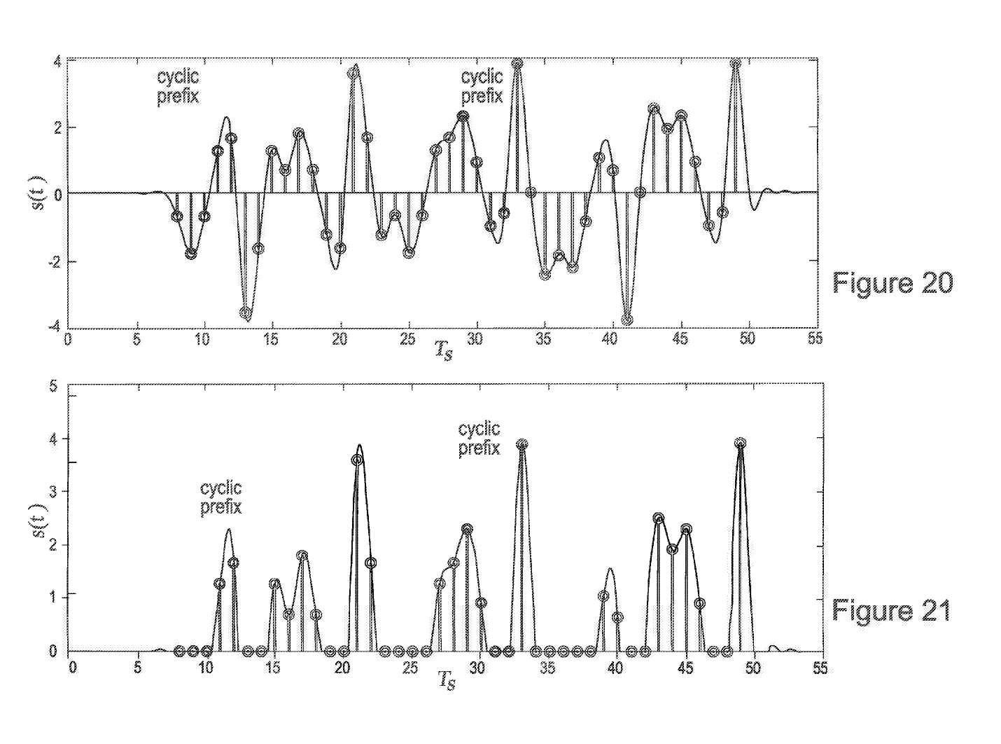

Discrete bipolar signals are shaped with bipolar pulse shapes (FIG. 20) and clipping is performed afterwards (FIG. 21).

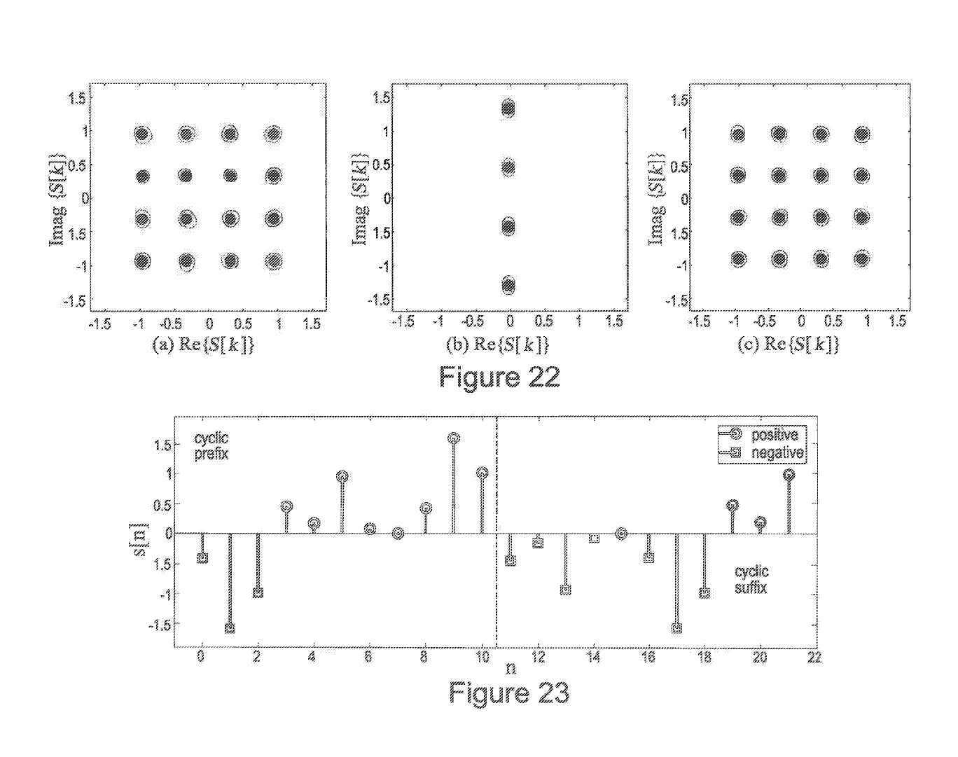

The useful signal is kept in the required band. Only the distortion term is attenuated by limited channel response. The necessary symmetry of the distortion term is kept after pulse shaping and after the channel effects for all three modulations. Some distortion is still present (see FIG. 22). The non-causal response of the pulse shaping filter disrupts the noise symmetry.

A physical communication channel has a causal impulse response, which makes a cyclic prefix sufficient for guarding a frame (see FIG. 23). A band-limited pulse shape like the raised cosine filter has a non-causal impulse response. Non-causal pulse shapes disrupt the symmetry of the distortion terms. A second guard interval (cyclic suffix) can mitigate this (FIG. 23).

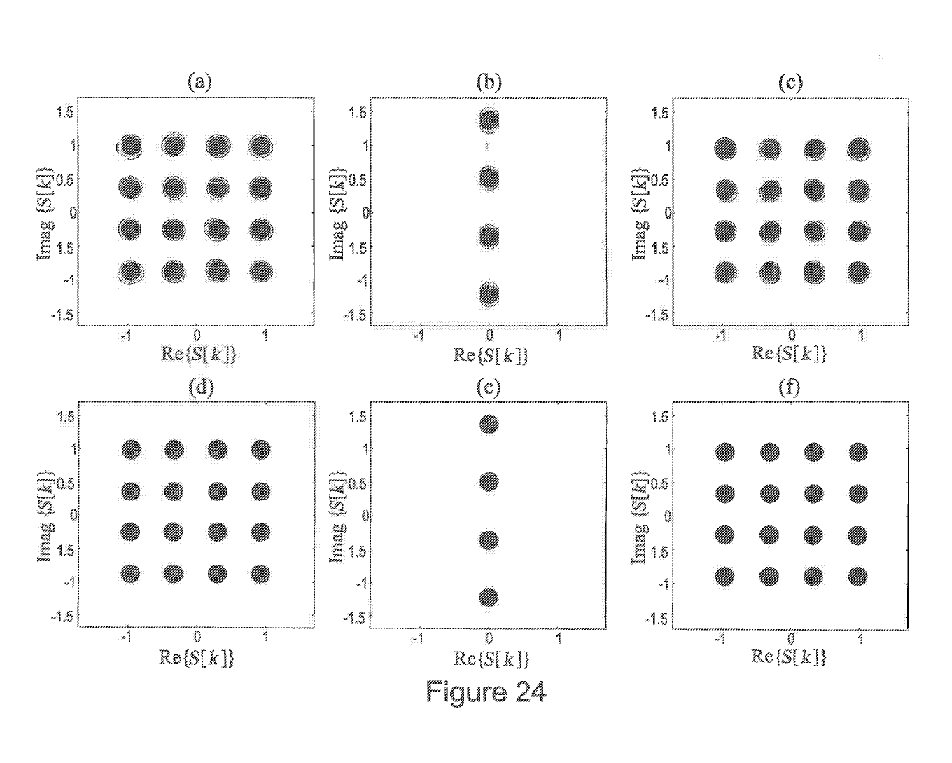

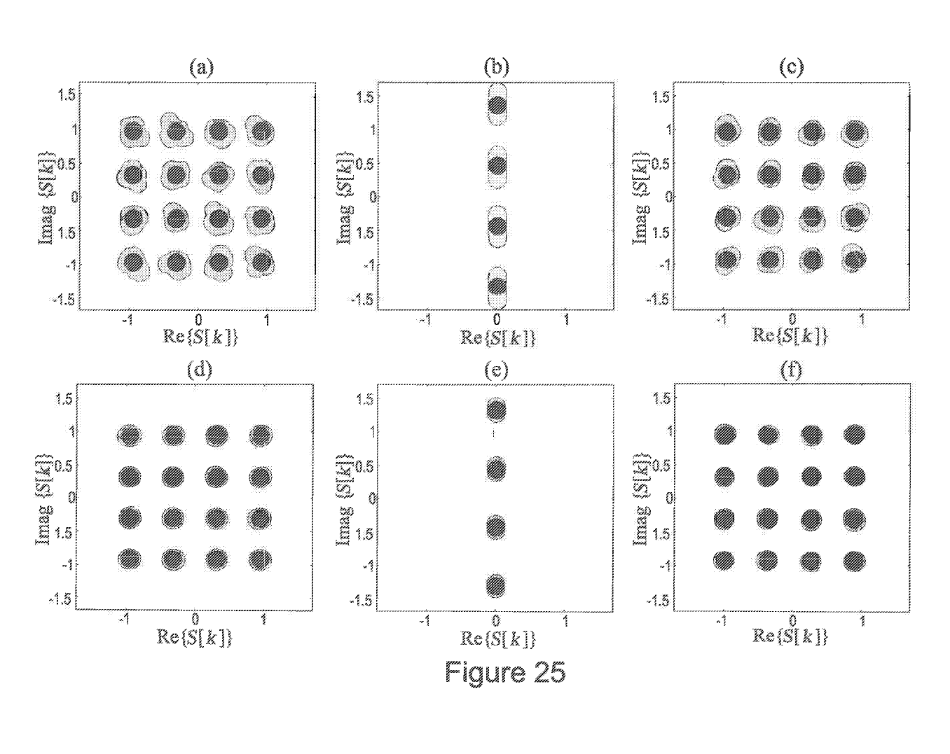

FIG. 24 shows distortion for: (a) 16-QAM ACO-OFDM with a prefix only. (b) 4-PAM PAM-DMT with a prefix only. (c) 16-QAM U-OFDM with a prefix only. (d) 16-QAM ACO-OFDM with a prefix and a suffix. (e) 4-PAM PAM-DMT with a prefix and a suffix. (f) 16-QAM U-OFDM with a prefix and a suffix, all of which are obtained with a root-raised cosine filter with a rolloff factor of 0.5. FIG. 25 is equivalent to FIG. 24 by obtained using a root raised cosine filter with a rolloff factor of 0.1;

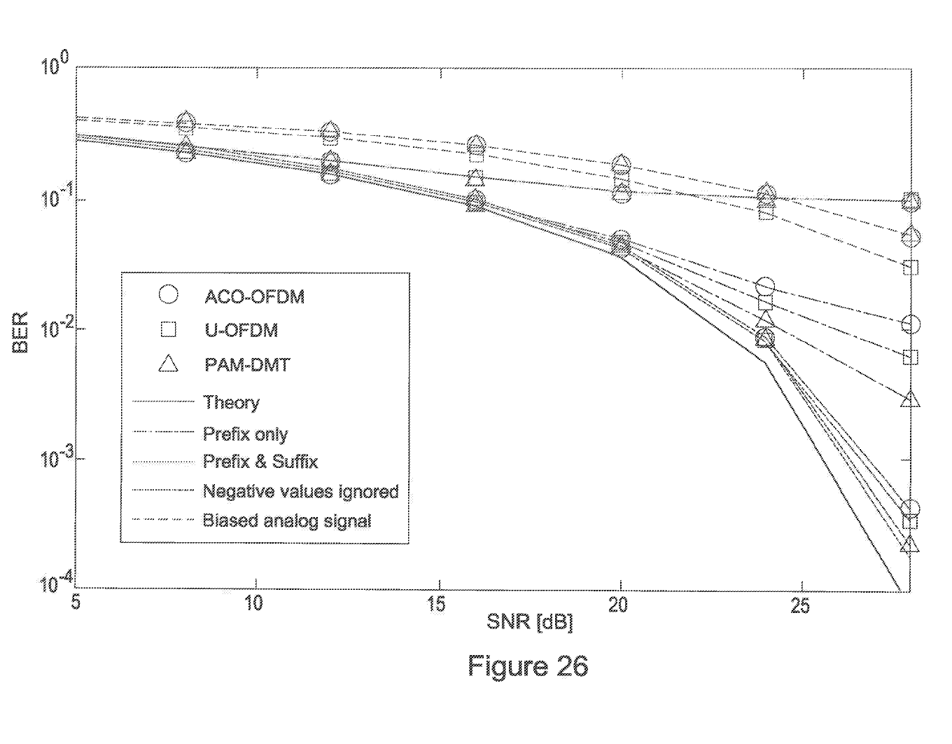

FIG. 26 shows effect of clipping scheme, prefix, suffix and biasing on the variation of Bit Error Rate (BER) with Signal to Noise Ratio (SNR), with a root raised cosine filter with rolloff of 0.1, N=32 carriers, 256 QAM.

The effect of the cyclic suffix in numbers is given below. S[k]=signal in frequency domain, S̅[k]=signal in frequency domain.

$$Signal \text{-} to \text{-} Distortion Ratio ( S D R ) = \frac{E [ {S}^{2} [ k ] ]}{E [ {( S [ k ] - \overline{S} [ k ] )}^{2} ]}$$

SDR in Different Scenarios (Root-raised cosine filter with rolloff factor of 0.1 has been used in these calculations. The QAM constellation size is 256).

| | ACO-OFDM | | PAM-DMT | | U-OFDM | |
|---|---|---|---|---|---|---|
| | SDR [dB] | | SDR [dB] | | SDR [dB] | |
| | Prefix | Prefix & | Prefix | Prefix & | Prefix | Prefix & |
| Nₘ | Only | Suffix | Only | Suffix | Only | suffix |
| 32 | 27.33 | 39.19 | 29.15 | 41.61 | 28.7 | 40.69 |
| 64 | 30.5 | 42.26 | 32.46 | 44.76 | 31.01 | 43 |
| 256 | 36.6 | 48.33 | 38.2 | 50.19 | 36.72 | 48.38 |

Cyclic suffix provides 12 dB improvement in SDR.

Discrete unipolar signals require unipolar pulse shapes. Bipolar pulse shaping can be applied as long as pulse shaping is applied before cupping the negative values. After pulse shaping, distortion terms still retain required symmetry to stay orthogonal to the useful information. Non-causal pulse shapes disrupt the symmetry of the distortion terms. A second guard interval (cyclic; suffix) can mitigate this.

The above method can also provide benefits with other bipolar to unipolar conversion techniques.

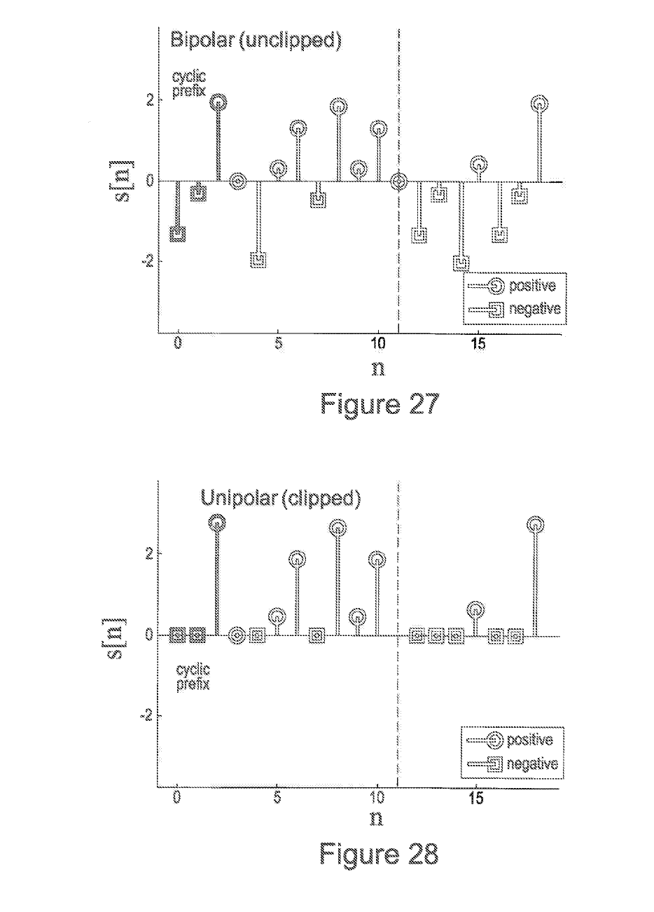

In Pulse-amplitude-modulated Discrete Multitone Modulation (PAM-DMT), Carriers are modulate with imaginary symbols only. This leads to a symmetry in time domain: s[n]=−s[N−n] (Lee et al., 2009), where N=number of carriers/number of FFT points and s[n]=time domain signal (see FIGS. 27 and 28).

Carriers are modulated with imaginary symbols <=> s[n]=−s[N−n]. Carriers are modulated with real symbols <=> s[n]=s[N−n]. CLIP(s[n])=(s[n]+|s[n]|)/2. This representation is important. In PAM-DMT, s[n]=−s[N−n]=>|s[n]|=|s[N−n]|. Therefore, distortion from clipping falls only on the real values in frequency domain.

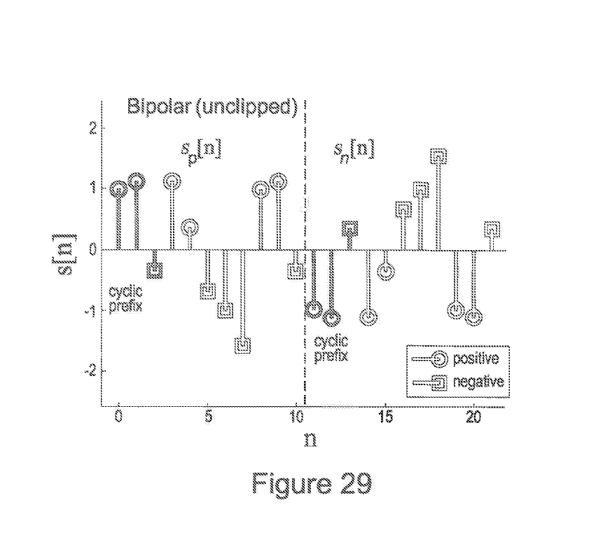

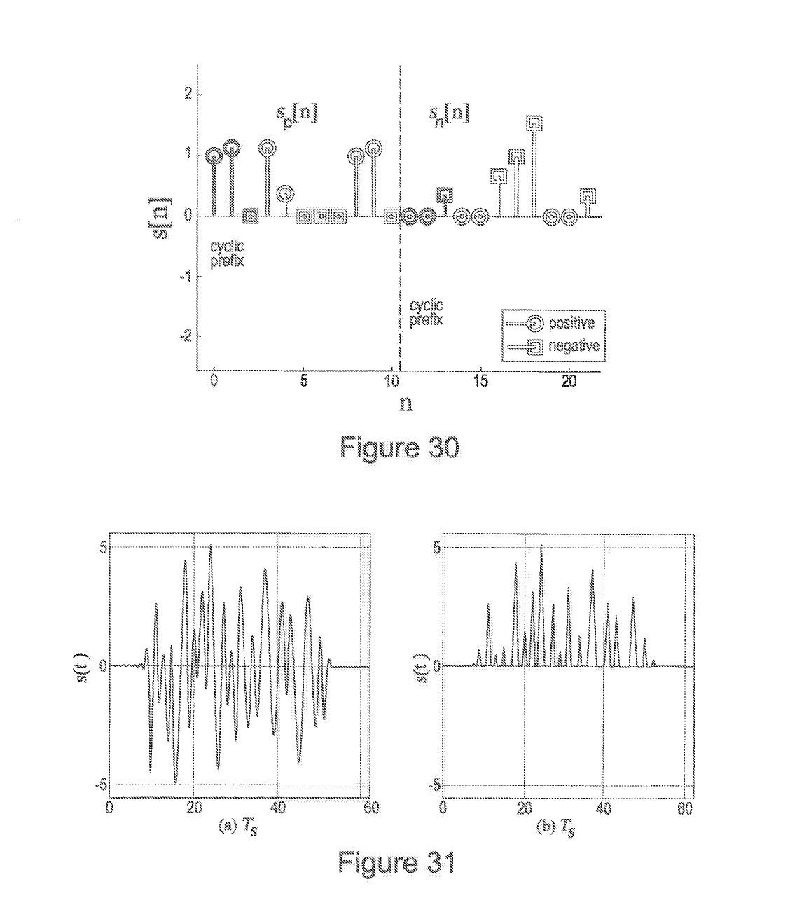

In Unipolar OFDM (U-OFDM)/Flip OFDM, Frames are sent in two streams. In the second stream with reversed signs. In this example the streams are two separate time frames, as shown in FIGS. 29 and 30.

Therefore, sₚ[n]=−sₙ[n] (Tsonev et al., 2012, Femando et al., 2011), where sₚ[n]=stream with positive samples and sₙ[n]=stream with negative samples.

In U-OFDM, by design: sₚ[n]=−sₙ[n]. Original signal is obtained as sₒ[n]=sₚ[n]−sₙ[n]. CLIP(s[n])=(s[n]+|s[n]|)/2. This representation is important sₚ[n]=−sₙ[n]=>|sₚ[n]|=|sₙ[n]|. Therefore, distortion from clipping is completely removed by the subtraction operation.

FIG. 31 shows (a) discrete bipolar ACO-OFDM signal, shaped with a root-raised cosine filter. (b) signal from (a), made unipolar through clipping.

Described herein is the issue of pulse shaping in unipolar orthogonal-frequency-division-multiplexing-based modulation schemes for intensity modulation/direct detection systems. Three previously presented schemes, asymmetrically dipped optical OFDM, pulse-amplitude-modulated discrete multitone modulation, and unipolar orthogonal frequency division multiplexing, are investigated. The current work demonstrates how both unipolar and bipolar pulse shapes can be used for the generation of unipolar continuous-time signals.

These aspects of the present invention are described below in the Appendix A of the Description.

A skilled person will appreciate that v nations of the disclosed arrangements are possible without departing from the invention.

For example, although the above embodiments have been described in relation to a system that uses a light source that comprises LEDs 25a, 25b, 25c, other light sources may be used, particularly light sources having a fast switching time that allows for modulation of the output.

In addition, although embodiments are described above that use intensity modulation and specifically on-off keying, it will be appreciated that other modulation schemes may be alternatively or additionally used, such as spatial modulation, colour modulation, multi-level intensity modulation and the like.

Although the embodiment of the present invention may use a portable electronics device, it will be appreciated that the electronics device need not be portable but that any suitably programmable or configurable device that comprises a camera and is capable of implementing a roiling shutter as described above may be used.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or nor-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1-53. (canceled)

54. A method for converting a signal from a bipolar signal into a unipolar signal, the method comprising:
applying a pulse shaping filter to the bipolar signal to produce a pulse shaped bipolar signal; and
subsequently transforming the negative values of the pulse shaped bipolar signal to produce the unipolar signal.

55. The method according to claim 54, wherein the method further comprises converting a discrete time signal into a continuous time signal, wherein an input signal comprises a discrete-time signal, which either is the bipolar signal or the bipolar signal is derived from the input signal, and the pulse shaped bipolar signal and/or the unipolar signal are continuous time signals.

56. The method of claim 54, wherein the pulse shaping filter at least one of comprises or applies at least one of a root-raised-cosine filter or a sinc function or a raised-cosine filter or a Gaussian function or a band-limited filter or pulse shape or a non-causal filter, pulse shape or response.

57. The method of claim 54, wherein the bipolar signal at least one of comprises or is representative of a real and bipolar signal or is derived from a modulation technique that produces a real and bipolar signal.

58. The method of claim 54, wherein at least one of the bipolar signal, the shaped bipolar signal, or the unipolar signal comprise a plurality of frames, and the frames comprise at least one guard interval.

59. The method of claim 58, wherein the guard interval(s) comprise at least one of a prefix or a suffix, wherein the prefix is provided before or at the start of at least one frame, and the suffix is provided after or at the end of at least one frame.

60. The method according to claim 59, wherein the suffix has a length that is dependent on the impulse response of the pulse shaping filter; and/or the frames comprise both cyclic prefix and cyclic suffix guard intervals.

61. The method according to claim 54, wherein transforming the negative values of the pulse shaped bipolar signal comprises at least one of clipping or transmitting only the absolute values of a bipolar signal using selected carrier channels and transmitting signs, phase or other information using spatial and/or spectral modulation.

62. The method according to claim 61, wherein the method further comprises using at least one of an asymmetrically clipped optical OFDM (ACO-OFDM), pulse amplitude modulated discrete multitone modulation (PAM-DMT), unipolar orthogonal frequency division multiplexing (U-OFDM) or Flip-OFDM technique.

63. A signal processor configured to convert a signal from a bipolar signal into a unipolar signal, the signal processor being configured to:
apply a pulse shaping filter to the bipolar signal to produce a pulse shaped bipolar signal; and
transform the negative values of the pulse shaped bipolar signal to produce the unipolar signal.

64. The signal processor according to claim 63, wherein the signal processor comprises:
at least one signal input for receiving an input signal;
a pulse shaper for shaping the signal; and
a transformation module for transforming the pulse shaped bipolar signal into a unipolar signal.

65. The signal processor according to claim 63, wherein the transformation module is configured to perform at least one of clipping or biasing and/or is configured to transform the negative values of the pulse shaped bipolar signal by arranging only the absolute values of a bipolar signal for transmission using selected carrier channels and arranging signs, phase or other information for transmission using spatial and/or spectral modulation.

66. The signal processor according to claim 63, wherein:
the input signal comprises a discrete-time signal, and the input signal is the bipolar signal or the bipolar signal is derived from the input signal;
the signal processor is configured to convert the discrete time signal into a continuous time signal; and
the pulse shaped bipolar signal and/or the unipolar signal are continuous time signals.

67. The signal processor according to claim 63, wherein:
the signal processor comprises at least one modulator for modulating the signal;
at least one of the one or more modulators are configured to apply an amplitude modulation scheme; and
at least one of the one or more modulators comprises an OFDM modulator configured to output the bipolar signal.

68. A transmitter comprising a signal processor and at least one transmitter element for transmitting a processed signal received from the signal processor, wherein the signal processor is configured to convert a signal from a bipolar signal into a unipolar signal, the signal processor being configured to apply a pulse shaping filter to the bipolar signal to produce a pulse shaped bipolar signal and transforming the negative values of the pulse shaped bipolar signal to produce the unipolar signal.

69. The transmitter according to claim 68, wherein the at least one transmitter element comprises an intensity modulated transmitter element and/or the transmitter is an optical transmitter for an optical communications system.

70. The transmitter according to claim 68, wherein the signal processor comprises or implements one or more modulators, the input signal comprises a bit stream and at least one of the one or more modulators is configured to apply an amplitude modulation scheme and at least one of the one or more modulators comprises an OFDM modulator, wherein the OFDM modulator is configured to output the bipolar signal.

71. A receiver comprising a signal processor and at least one receiver element for receiving a processed signal, the signal processor comprising a filter for filtering a signal, at least one demodulator for demodulating a signal and an output for outputting an output signal, wherein the receiver element is configured to receive a unipolar signal and the signal processor is configured to convert the unipolar signal into a bipolar signal.

72. A communications system, the communications system comprising at least one transmitter according to claim 68, for transmitting one or more signals and at least one receiver for receiving the signal, wherein the receiver comprises a signal processor and at least one receiver element for receiving the signal, the signal processor comprising a filter for filtering the signal, at least one demodulator for demodulating the signal and an output for outputting an output signal, wherein the received signal is a unipolar signal and the signal processor is configured to convert the unipolar signal into a bipolar signal.

73. The communication system according to claim 72, wherein the communications system is configured to convert a discrete time signal into a continuous time signal at a signal processor or transmitter and/or be configured to convert a continuous time signal into a discrete time signal at a receiver.
